(19) United States
(12) Patent Application Publication
(10) Pub. No.: US 2007/0245481 A1
(43) Pub. Date: Oct. 25, 2007

(54) WATER PUMP

(76) Inventor: Jack Chen, Taichung City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/379,694

(22) Filed: Apr. 21, 2006

(51) Int. Cl. A61H 33/02

(52) U.S. Cl. 4/541.4

(57) ABSTRACT

A water pump is arranged at a predetermined position along a drainage pipeline of a foot bubbler or a massage bathtub, and comprises: a motor connected to a suction housing, a rotary shaft of the motor extending into the suction housing and being provided with an impeller, an inlet pipe and an outlet pipe being connected to the suction housing. The water pump is characterized in that: an air exit connector is arranged in a circumferential surface of the inlet pipe for connecting an air exit pipe, a check valve is disposed in the outlet pipe to prevent the occurrence of reversal flow of dirty water, thus preventing the water in the tub from contamination.

### BACKGROUND OF THE INVENTION

1. Field of the Invention

The present invention relates to a pump, and more particularly to a water pump arranged at an appropriate position along the drainage pipeline of a foot bubbler or a massage bathtub, which can drain water out of the tub successfully.

2. Description of the Prior Art

Along with the improvement of living standard, massage bathtub and foot bubbler with water therapy and massage function are becoming more popular. And for the purpose of drainage, a water pump is usually arranged at an appropriate position (particularly in the underground chamber) in a drainage pipeline. FIG. 1 shows a conventional water pump which comprises a motor 1 serving to rotate the impeller 3 inside a suction housing 2, an inlet pipe 4 and an outlet pipe 5 are connected to the suction housing 2. When the impeller 3 rotates, water is sucked from the inlet pipe 4 to the outlet pipe 5, and thus the water can be drained.

However, this conventional water pump has the following disadvantages:

First, if there is air left in the drainage pipeline, the water pump will probably be unable to successfully impel the water inside the pipeline, as a result, the motor 1 will idle and can't suck any water, and even worse, the motor 1 will probably be burned out.

Second, when the pump stops rotation, the water inside the pipeline will flow back because of the pressure difference and bring the dirty water back into the foot bubbler or the massage tub.

The present invention has arisen to mitigate and/or obviate the afore-described disadvantages.

### SUMMARY OF THE INVENTION

The primary objective of the present invention is that when there is air left in the drainage pipeline, the air can be expelled out of the air exit connector via the air exit pipe, ensuring that the water pump can drain water successfully from the drainage pipeline, thus preventing the motor from idling, being burned, or being unable to drain water.

The secondary objective of the present invention is that the water pump is provided with a check valve, when the water pump stops operation, the check valve can close the outlet pipe to prevent the flow reversal in the drainage pipeline, thus preventing the water in the tub from contamination.

A water pump provided by the present invention is arranged at a predetermined position along a drainage pipeline of a foot bubbler or a massage bathtub, and comprises: a motor connected to a suction housing, a rotary shaft of the motor extending into the suction housing and being provided with a impeller, an inlet pipe and an outlet pipe being connected to the suction housing. An air exit connector is arranged in a circumferential surface of the inlet pipe for connecting an air exit pipe, a check valve is disposed in the outlet pipe for preventing the occurrence of reversal flow of dirty water, an enlarged pipe portion is formed at an end of the inlet pipe, the enlarged pipe portion is formed in its outer circumferential surface with outer threads to be screwed with a connecting device and is provided on the inner surface thereof with a plurality of slide rails on which the check valve is slidably installed. By such arrangements, the rotation of the impeller can enable the water to be drained successfully from the inlet pipe to the outlet pipe.

The present invention will be more clear from the following description when viewed together with the accompanying drawings, which show, for purpose of illustrations only, the preferred embodiment in accordance with the present invention.

### BRIEF DESCRIPTION OF THE DRAWINGS

FIG. 1 is a perspective view of a conventional pump;

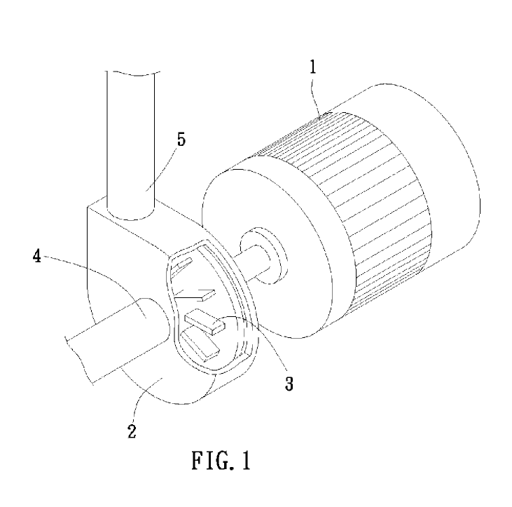

FIG. 2 is a perspective view of a water pump in accordance with the present invention;

FIG. 3 is an exploded view of the water pump in accordance with the present invention;

FIG. 4 is an assembly view of the water pump in accordance with the present invention;

FIG. 5 is a cross sectional view of the water pump in accordance with the present invention;

FIG. 6 is an operational view of the water pump in accordance with the present invention; and

FIG. 7 is an operational view of the water pump in accordance with the present invention, wherein the outlet pipe is closed by the check valve.

### DETAILED DESCRIPTION OF THE PREFERRED EMBODIMENT

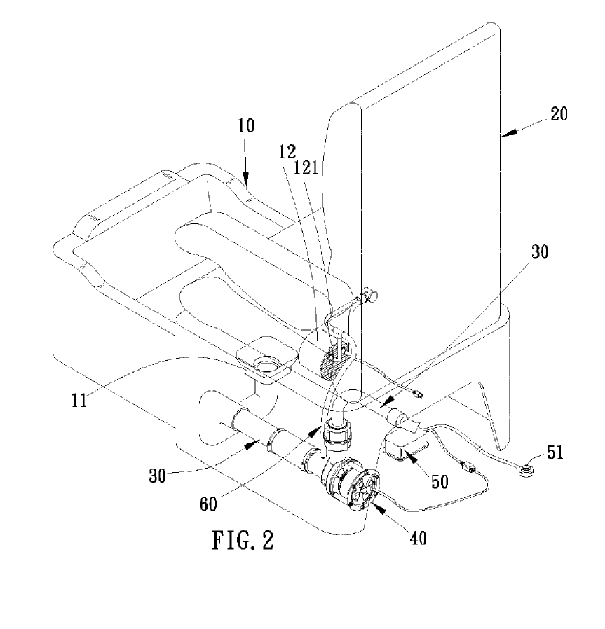

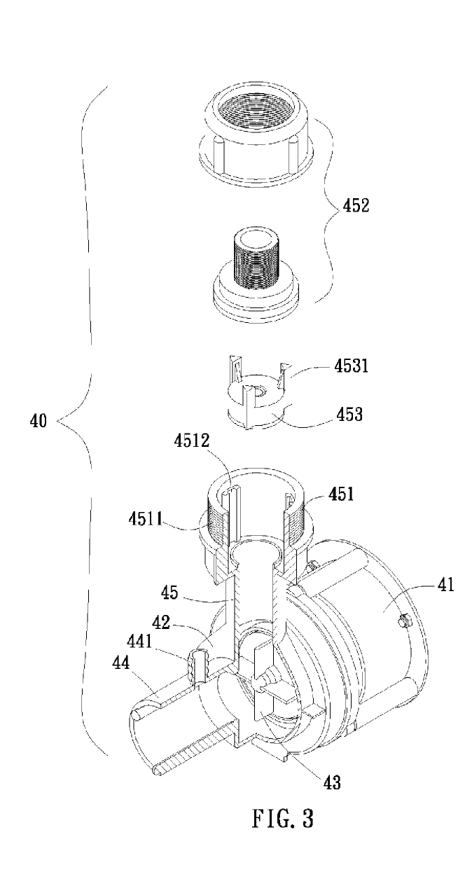

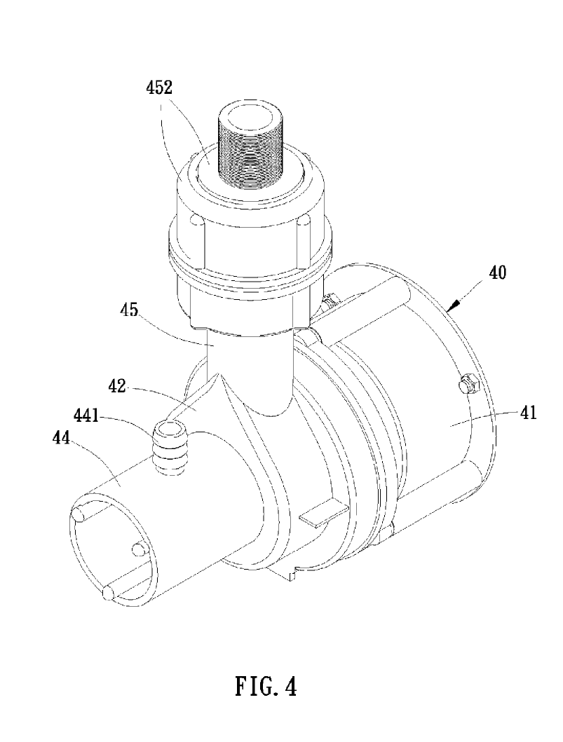

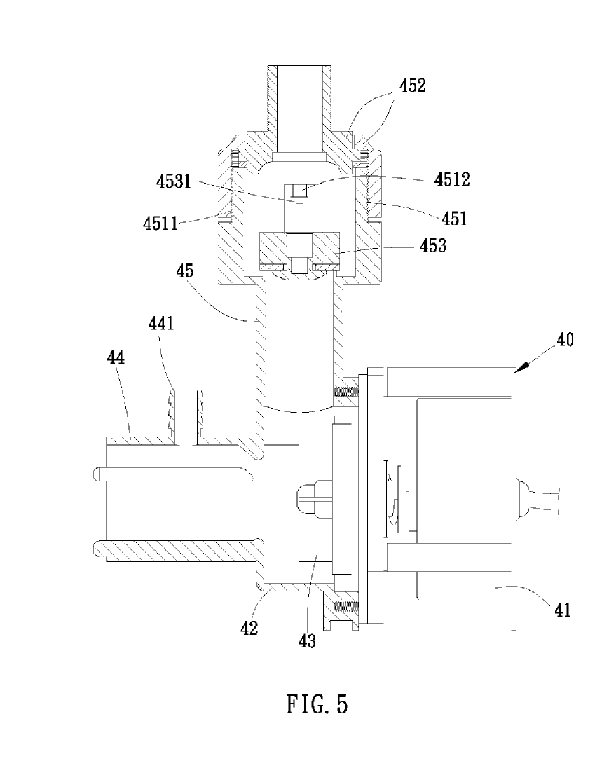

Referring to FIGS. 2-5, a water pump in accordance with the present invention is arranged at an appropriate position along the drainage pipeline of a foot bubbler (or a massage bathtub). A seat 20 is disposed at the rear end of a tub 10, and an outlet hole 11 is formed in the bottom of the tub 10. A massage shower 12 is arranged at a predetermined height on the wall of the tub 10, and located beneath the seat 20 are drainage pipeline 30, a water pump 40, and a transformer 50 which is controlled by air pressure and a switch 51. The drainage pipeline 30 has one end connected to the outlet hole 11 and has another end extended out of the tub. The pump 40 includes a motor 41 connected to a suction housing 42. The rotary shaft of the motor 41 extends into the suction housing 42 and is to be assembled with an impeller 43. An inlet pipe 44 and an outlet pipe 45 are connected to the suction housing 42, and the outlet pipe 45 is also connected to the drainage pipeline 30. An air exit connector 441 is arranged in the circumferential surface of the inlet pipe 44, and an enlarged pipe portion 451 is formed at the end of the inlet pipe 44. The enlarged pipe portion 451 is formed in its outer circumferential surface with outer threads 4511 to be screwed with a connecting device 452 and is provided on the inner surface thereof with a plurality of slide rails 4512 on which the legs 4531 of the check valve 453 are slidably installed.

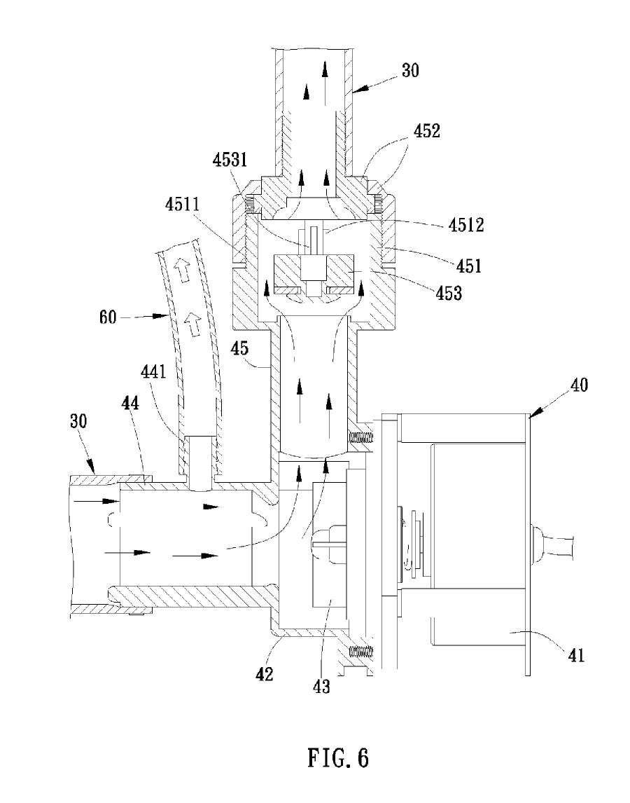

In use, as shown in FIG. 6, the air-introduction connector 441 is provided for connecting an air exit pipe 60. The air exit pipe 60 is arranged independently or is connected to the air pipe 121 of the massage nozzle 12 via a Tee joint 61. If want to drain water out of the tub 10, the transformer 50 can control the operation of the water pump 40, the rotation of the impeller 43 makes the water flow through the outlet hole 11, the drainage pipeline 30, the front section of the inlet pipe 44 to the outlet pipe 45, then the water pushes open the check valve 453 and is finally drained from the rear section of the drainage pipeline 30. If there is air left in the drainage pipeline 30, the air can be expelled out of the air exit connector 441 via the air exit pipe 60, ensuring that the water pump 40 can drain water successfully from the drainage pipeline 30.

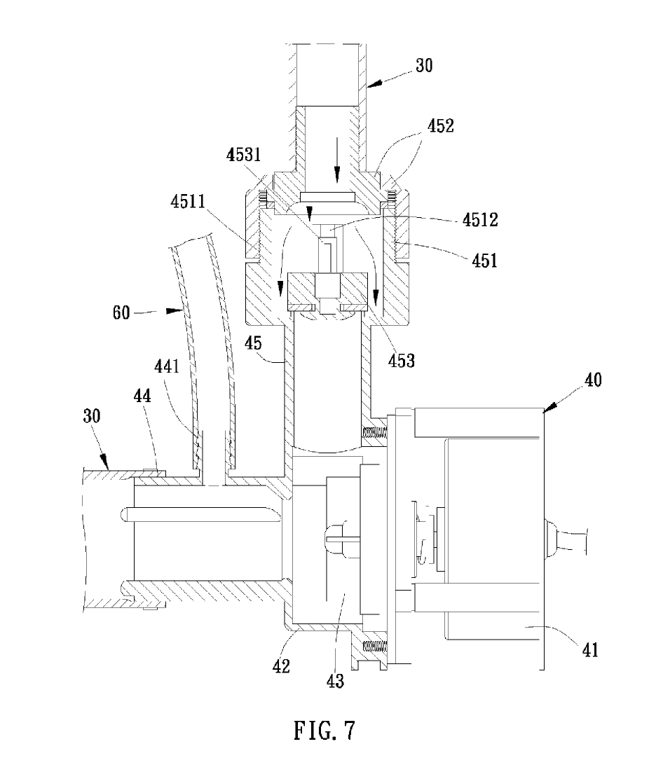

When the water pump 40 stops operation, as shown in FIG. 7, the check valve 453 closes the outlet pipe 45 to prevent the flow reversal in the drainage pipeline 30, thus preventing the water in the tub 10 from contamination.

To summarize, the present invention has the following advantages:

First, when want to drain water out of the tub and there is air left in the drainage pipeline 30, the air can be expelled out of the air exit connector 441 via the air exit pipe 60, ensuring that the water pump 40 can drain water successfully from the drainage pipeline 30, thus preventing the motor 41 from idling, being burned, or being unable to drain water.

Second, the water pump 40 is provided with a check valve 453, when the water pump 40 stops operations, the check valve 453 can close the outlet pipe 45 to prevent the flow reversal in the drainage pipeline 30, thus preventing the water in the tub 10 from contamination.

While we have shown and described various embodiments in accordance with the present invention, it is clear to those skilled in the art that further embodiments may be made without departing from the scope of the present invention.

What is claimed is:

1. A water pump arranged at a predetermined position along a drainage pipeline of a foot bubbler or a massage bathtub, comprising: a motor connected to a suction housing, a rotary shaft of the motor extending into the suction housing and being provided with a impeller, an inlet pipe and an outlet pipe being connected to the suction housing; the water pump is characterized in that:
an air exit connector is arranged in a circumferential surface of the inlet pipe for connecting an air exit pipe, a check valve is disposed in the outlet pipe for preventing the occurrence of reversal flow of dirty water.

2. The water pump as claimed in claim 1, wherein an enlarged pipe portion is formed at an end of the inlet pipe, the enlarged pipe portion is formed in its outer circumferential surface with outer threads to be screwed with a connecting device and is provided on the inner surface thereof with a plurality of slide rails on which legs of the check valve are slideably installed.

3. The water pump as claimed in claim 1, wherein the air exit pipe is connected to an air pipe of a massage nozzle by a Tee joint.

4. The water pump as claimed in claim 1, wherein the air exit pipe is arranged independently.
